(19) United States
(12) Patent Application Publication
(10) Pub. No.: US 2017/0054139 A1
(43) Pub. Date: Feb. 23, 2017

(54) GALVANIC ELEMENT AND METHOD FOR THE PRODUCTION THEREOF

(71) Applicant: Robert Bosch GmbH, Stuttgart (DE)

(72) Inventor: Ingo Kerkamm, Stuttgart-Rohr (DE)

(21) Appl. No.: 15/307,072

(22) PCT Filed: Apr. 8, 2015
(86) PCT No.: PCT/EP2015/057624

§ 371 Date: Oct. 27, 2016

(30) Foreign Application Priority Data
Apr. 30, 2014 (DE) 102014208228.5

(51) Int. Cl. H01M 4/04; H01M 10/44; H01M 4/36; H01M 10/0525; H01M 10/0565; H01M 4/62; H01M 4/38; H01M 4/131

(52) U.S. Cl. CPC H01M 4/0447; H01M 4/382; H01M 10/446; H01M 4/131; H01M 10/0525; H01M 10/0565; H01M 4/625; H01M 4/364; H01M 2004/027

(57) ABSTRACT

A method for producing a galvanic element that includes the following steps: a) production of a layer sequence including, in this order, a current conductor assigned to an anode, an ion-conducting and electrically insulating separator, a cathode having lithium-containing cathode material, and a current conductor assigned to the cathode, and b) charging of the galvanic element, an anode including metallic lithium forming between the current conductor assigned to the anode and the separator during charging of the galvanic element. In addition, a battery cell including such a galvanic element, and a battery including a plurality of such battery cells, are also described.

### FIELD

The present invention relates to a galvanic element and to a method for producing such a galvanic element, the galvanic element including a current conductor assigned to the anode, an anode, a separator, a cathode, and a current conductor assigned to the cathode. In addition, the present invention relates to a battery cell including such a galvanic element, and to a battery including a plurality of such battery cells.

### BACKGROUND INFORMATION

Lithium-ion batteries are distinguished, inter alia, by a very high specific energy and an extremely low self-discharge. Lithium-ion cells have at least one positive electrode and at least one negative electrode (cathode or, respectively anode), and during the charging and discharging of the battery lithium ions migrate from one electrode to the other electrode. For the transport of the lithium ions, a so-called lithium-ion conductor is necessary. In lithium-ion cells currently used, for example in consumer electronics (mobile telephones, MP3 players, etc.) or as energy storage units in electric or hybrid vehicles, the lithium-ion conductor is a liquid electrolyte, which frequently contains the lithium-conductive salt lithium hexafluorophosphate (LiPF₆) dissolved in organic solvents. A lithium-ion cell includes the electrodes, the lithium-ion conductor, and current conductors that produce the electrical connections.

The lithium-ion cells can be enclosed in a packaging. Aluminum compound foils can for example be used as packaging. Cells packaged in this way are also referred to as pouch, or softpack, due to their soft packaging. In addition to the softpack packaging design, hard metal housings can also be used as packagings, for example in the form of deep-drawn or extruded housing parts. In this case one speaks of a hard housing, or hard case.

A disadvantage of lithium-ion cells having liquid electrolyte is that under mechanical and thermal stress the liquid electrolyte components can decompose, resulting in excess pressure in the cell. Without corresponding protective measures, this can cause the cell to burst or even to ignite.

It is possible to use a solid ceramic, or inorganic, lithium-ion conductor instead of a liquid electrolyte. This design avoids the bursting of the battery cell or leakage of materials when the packaging is damaged.

German Patent Application No. DE 10 2012 205 931 A1 describes an electrochemical energy storage device and a method for its production. The electrochemical energy storage device includes at least one electrode assembly in which an ion-conducting and electrically insulating separator layer is fashioned on a coated surface. The ion-conducting layer is used as electrolyte, so that a liquid electrolyte no longer has to be used. As active materials for the electrode assemblies, for the realization as lithium-ion cell a lithium metal oxide, for example lithium cobalt oxide, is proposed for the cathode, and graphite is proposed for the anode. As initial material for the ion conductor, a ceramic powder is proposed having for example 0.3 to 3 μm particle size, for example lithium garnet. The ceramic powder can be applied onto the surface to be coated for example in the form of an aerosol.

A disadvantage of the use of a graphite anode is its comparatively low energy density compared to an anode based on lithium metal. Lithium metal-based anodes in turn are difficult to handle during the production of a galvanic element, because lithium has a high reactivity and is stable only in completely dry environments.

### SUMMARY

A method is provided for producing a galvanic element, the method having the following steps:
a) production of a layer sequence including, in this order, a current conductor assigned to an anode, an ion-conducting and electrically insulating separator, a cathode having cathode material containing lithium, and a current conductor assigned to the cathode, and
b) charging of the galvanic element,

an anode including metallic lithium forming during charging of the galvanic element between the current conductor assigned to the anode and the separator.

The layer sequence can be produced for example in that, in a first step i), the current conductor assigned to the anode is provided. In a second step ii), the ion-conducting and electrically insulating separator is applied on the current conductor assigned to the anode. In a third step, the cathode having cathode material containing lithium is then applied on the separator. In a final step iv), the current conductor assigned to the cathode is then situated on the cathode.

In the first step i) of the production of the layer sequence, the current conductor assigned to the anode is provided. The current conductors are typically made of metal foils, copper foils having thicknesses between 6 μm and 12 μm typically being used for the current conductors assigned to the anode. Also conceivable would be the use of different materials as bearer on which a copper layer is applied. Standardly, the side of the current conductor facing the anode is subjected to a surface treatment in order to prevent a reaction with metallic lithium.

In the second step ii) of the production of the layer sequence, the ion-conducting and electrically insulating separator is applied on the current conductor assigned to the anode in the form of a layer. The layer is preferably made sealed. The material of the separator is preferably a ceramic material which, in a specific embodiment of the method, is applied in the form of a ceramic powder using aerosol coating. A suitable method is described, for example, in German Patent Application No. DE 10 2012 205 931 A1. It is also possible to use other conventional coating methods, such as PLD (Pulsed Laser Deposition), or similar gas phase coating methods. The separator produced in this way has a residual porosity of less than 5%. The separator has no through-going porosity, and is thus completely tight. Preferably, the tight separator layer is realized having a thickness of 5-25 μm, particularly preferably a thickness in the range of from 8-15 μm.

The material of the separator is preferably a lithium-conducting ceramic. In particular, lithium garnet is suitable as material for the separator. Alternatively, the material of the separator can be selected from perovskites (LLTO) Li3xLa2/3-xTiO₃, phosphates (LATP) Li1+xTi2=xTi2-xMx(PO4)3 (where M=Al, Ga, In, or Sc), sulfidic glasses containing Li₂S and P₂S₅, and doping elements such as Ge and Sn and argyrodites Li₆PS₅X (where X=I, Cl, or Br).

In the third step iii) of the production of the layer sequence, a cathode is applied on the separator in the form of a layer of a cathode material containing lithium. The cathode material can for example be prepared to form a paste or a slurry, applied onto the separator. Other conventional coating methods can also be used.

The cathode material is preferably a mixture of a cathode active material, pre-lithiated if warranted, an electrically conductive material, and an ionically conductive catholyte. In a preferred specific embodiment, the cathode active material can be present as a composite material having carbon in order to increase the electrical conductivity.

In a specific embodiment of the method, the composite material includes a mixture of sulfur particles as active material, graphite, and conductive carbon black in order to increase the electrical conductivity, and, if warranted, a binder such as PVdF (polyvinylidene fluoride). In a further specific embodiment of the method, the cathode active material includes a mixture of SPAN (sulfur polyacrylonitrile), graphite, and/or conductive carbon black, and a polymer that conducts lithium ions. In a further specific embodiment, the composite material includes a mixture of, if warranted, carbon, as well as nanoparticles of LiF and a metal such as Fe, Cu, Ni. In a further specific embodiment, the composite material includes a mixture of, if warranted, carbon, as well as nanoparticles of Li₂S and a metal such as Fe, Cu, Ni. In another specific embodiment, the pre-lithiation of the metal has already taken place, and the composite material is made up of carbon and a lithium-containing metal hydride, sulfide, fluoride, or nitride.

In order to prevent a migration of the fluorine, and thus a reaction with the catholyte, a reaction with the current conductor, or reactions with other battery components, in a preferred embodiment the composite material is provided with a coating, e.g., of carbon or an oxide (e.g. Al₂O₃) or fluoride (e.g. AlF₃) or oxyfluoride. A coating can also prevent the diffusion of polysulfides in the sulfur-containing specific embodiment.

In a further specific embodiment of the method, the cathode active material is selected from a lithiated transition metal oxide, for example Li(NiCoMn)O₂, LiMn₂O₄ (or higher Li content), Li₂MO₃—LiMO₂ (where M is for example Ni, Co, Mn, Mo, Cr, Fe, Ru, or V), LiMPO₄ (where M is for example Fe, Ni, Co, or Mn), Li(Ni_{0.5}Mn_{1.5})O₄ (or higher Li content), LiₓV₂O₅, LixV₃O₈, or further conventional cathode materials, such as borates, phosphates, fluorophosphates, silicates.

In a further specific embodiment of the method, the cathode active material is selected from a lithiated sulfur, for example Li₂S, the material preferably being encapsulated in a carbon composite matrix, for example in the form of small spheres, in order to prevent dissolving or side reactions with the catholyte.

In a specific embodiment of the method, the catholyte is an electrolyte based on polyethylene oxide (PEO), or on soy.

Alternatively or in addition, it is possible also to use the materials used for the ion-conducting separator as catholyte, because these materials also have good ionic conductivity. In addition, the catholyte may still have an electrical conductivity, which however does not necessarily have to be the case.

In a specific embodiment of the method, the conductive material is selected from carbon nanotubes, a conductive carbon black, graphene, graphite, or a combination of at least two of these materials.

In the fourth step iv) of the production of the layer sequence, the current conductor assigned to the cathode is applied onto the cathode. The current conductor assigned to the cathode can in turn be made of a metal foil, an aluminum foil having a thickness between 13 μm and 15 μm standardly being used for the cathode. Alternatively, it is in turn possible to use a bearer material coated with aluminum as the current conductor assigned to the cathode. In a further alternative, it would be conceivable to apply the material for the current conductor assigned to the cathode using a conventional coating method, for example vapor deposition.

In addition, the current conductor assigned to the cathode can also be subjected to a surface treatment in order to prevent reactions between the materials contained in the galvanic element and the material of the current conductor, for example aluminum.

Depending on the specific embodiment of the method, the steps i) through iv) can also be executed in a different order. For example, it is possible to carry out steps i) and ii) separately, and parallel thereto to provide a current conductor assigned to the cathode, to apply the cathode on this conductor, and subsequently to join the two components.

Subsequently, the charging according to step b) can be carried out as the final step.

In the second and final step b) of the method, the galvanic element produced in step a) of the method is electrically charged for the first time. When this is done, lithium ions migrate from the cathode active material in the cathode through the ion-conducting separator, and deposit, in the form of a layer of metallic lithium, on the side facing the separator of the current conductor assigned to the anode. In this way, an anode including metallic lithium is fashioned between the current conductor assigned to the anode and the separator.

In addition, a battery cell is proposed including a cell packaging and a galvanic element that is produced according to the method just described. The cell packaging can be a softpack design or a hard housing.

In addition, a battery is proposed including one or more such battery cells.

In the context of this description, the term “battery” or “battery cell” is used as is standard in colloquial language; i.e., the term “battery” includes both a primary battery and also a secondary battery (accumulator). In the same way, the term “battery cell” includes both a primary cell and also a secondary cell.

Through the method according to the present invention, a galvanic element can be produced having high capacitance and large energy density. The high capacitance is achieved through the use of a metallic lithium anode. This high energy density of the anode is advantageously combined with an ion-conducting separator, so that liquid electrolyte can be done without. In preferred specific embodiments, the use of lithium garnet as ion-conducting separator is proposed, which ensures a particularly high ion conductivity, and thus also ensures, in addition to the high energy density, a high performance of the galvanic element. The produced separator has a residual porosity of less than 5%, no through-going porosity being present, and the separator thus being completely tight.

Advantageously, according to the method of the present invention, despite the use of an anode based on metallic lithium it is not necessary to handle metallic lithium during the production. In the production of the galvanic element, the lithium is introduced in the form of a lithiated cathode active material, which is stable and easier to handle in comparison with metallic lithium.

### BRIEF DESCRIPTION OF THE DRAWINGS

FIG. 1 shows a galvanic element before the charging according to step b).

FIG. 2 shows a galvanic element after the charging according to step b).

### DETAILED DESCRIPTION OF EXAMPLE EMBODIMENTS

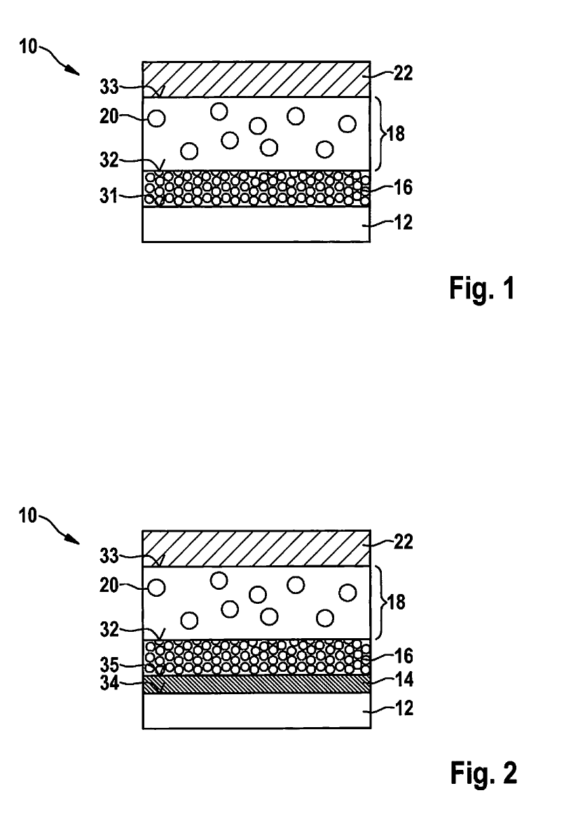

FIG. 1 shows a galvanic element 10. In the situation shown in FIG. 1, step a) of the method is carried out. Here, steps i) through iv) are run through in order to produce the layer sequence. First, in step i) a current conductor 12 assigned to the anode is provided. This is realized for example as copper foil. In the second step ii), a separator 16 is applied on current conductor 12 assigned to the anode, a first boundary layer 31 forming between current conductor 12 assigned to the anode and separator 16. As initial product for separator 16, a ceramic powder is suitable, applied for example by aerosol coating onto current conductor 12 assigned to the anode. As ceramic powder, in particular lithium garnet is suitable, which has good conductivity for lithium ions. Separator 16 is not electrically conductive, so that it also assumes the function of an electrical insulator.

In the third step iii), a cathode 18 is applied onto separator 16, so that a second boundary layer 32 forms that is situated on the side of separator 16 facing away from first boundary layer 31. Cathode 18 includes a lithium-containing cathode material that preferably includes a mixture of a cathode active material 20, a conductive material, and a catholyte. The cathode material can be applied using conventional methods. For example, the cathode material can be applied onto separator 16 in the form of a paste.

In step iv), a current conductor 22 assigned to the cathode is applied onto cathode 18, a third boundary layer 33 forming that is situated on the side of cathode 18 facing away from second boundary layer 32. Current conductor 22 assigned to the cathode is for example realized as aluminum foil. The aluminum foil can be connected to the cathode material of cathode 18 for example by being placed onto cathode 18 and subsequently pressed.

Because in the situation shown in FIG. 1 galvanic element 10 has not been charged for the first time, it still has no anode. For charging according to step b) of the method, the two current conductors 12, 22 are electrically contacted and charged with a voltage so that a charge current can flow. Caused by the charge current, lithium ions separate from cathode active material 20 and migrate through separator 16 in the direction of current conductor 12 assigned to the anode, where they deposit in the region of first boundary layer 31.

In FIG. 2, galvanic element 10 is shown in a state after the first charging of galvanic element 10 according to step b) of the method. Galvanic element 10 now includes current conductor 12 assigned to the anode, an anode 14 formed on current conductor 12 assigned to the anode through the deposition of lithium ions, separator 16, cathode 18 having cathode active material 20, and current conductor 22 assigned to the cathode.

Through the charging of galvanic element 10 according to step b) of the method, parts of cathode active material 20 have de-lithiated, and the lithium ions exiting from cathode active material 20 have migrated through separator 16 in the direction of current conductor 12 assigned to the anode. There, the lithium ions have deposited as anode 14 in the form of a layer of metallic lithium. As a consequence, first boundary layer 31 between current conductor 12 assigned to the anode and separator 16 has been dissolved, and a fourth boundary layer 34 and fifth boundary layer 35 have been newly formed. The fourth boundary layer 34 is fashioned between current conductor 12 assigned to the anode and anode 14, and correspondingly fifth boundary layer 35 is fashioned between anode 14 and separator 16.

When the battery is discharged, this process is again partly reversed. Lithium ions will then exit from the anode active material, migrate through separator 16, and will re-lithiate cathode active material 20.

The present invention is not limited to the exemplary embodiments described here and the aspects emphasized therein. Rather, a large number of modifications are possible that lie within the scope of activity of those skilled in the art are possible.

1-10. (canceled)

11. A method for producing a galvanic element, comprising:
producing a layer sequence including, in this order, a current conductor assigned to an anode, an ion-conducting and electrically insulating separator, a cathode having lithium-containing cathode material, and a current conductor assigned to the cathode; and
charging the galvanic element;
wherein during the charging of the galvanic element, an anode is formed including metallic lithium between the current conductor assigned to the anode and the separator.

12. The method as recited in claim 11, wherein the separator is applied using aerosol coating or pulsed laser deposition.

13. The method as recited in claim 11, wherein a material of the separator is a lithium-conducting garnet.

14. The method as recited in claim 13, wherein a material of the separator is lithium garnet.

15. The method as recited in claim 11, wherein a cathode material of the cathode is a mixture that includes a cathode active material, a conductive material, and a catholyte.

16. The method as recited in claim 15, wherein the cathode active material (20) is selected from a composite material containing LiF and a metal, a lithiated transition metal oxide, or a lithiated sulfur.

17. The method as recited in claim 15, wherein the catholyte is an electrolyte based on polyethylene oxide (PEO) or on soy.

18. The method as recited in claim 15, wherein the conductive material is selected from carbon nanotubes, a conductive carbon black, graphene, graphite, or a combination of at least two of these materials.

19. A battery cell, comprising:
a cell housing; and
a galvanic element produced by producing a layer sequence including, in this order, a current conductor assigned to an anode, an ion-conducting and electrically insulating separator, a cathode having lithium-containing cathode material, and a current conductor assigned to the cathode, and charging the galvanic element, wherein during the charging of the galvanic element, an anode is formed including metallic lithium between the current conductor assigned to the anode and the separator.

20. A battery including one or more battery cells, the battery cells comprising:
a cell housing; and
a galvanic element produced by producing a layer sequence including, in this order, a current conductor assigned to an anode, an ion-conducting and electrically insulating separator, a cathode having lithium-containing cathode material, and a current conductor assigned to the cathode, and charging the galvanic element, wherein during the charging of the galvanic element, an anode is formed including metallic lithium between the current conductor assigned to the anode and the separator.
